(19) United States
(12) Patent Application Publication
(10) Pub. No.: US 2006/0161972 A1
(43) Pub. Date: Jul. 20, 2006

(54) System and method for license management in blade server system

(76) Inventors: Daryl Carvis Cromer, Apex, NC (US); Howard Jeffrey Locker, Cary, NC (US); Randall Scott Springfield, Chapel Hill, NC (US); Rod David Waltermann, Rougemont, NC (US)

Correspondence Address: ROGITZ & ASSOCIATES, 750 B STREET, SUITE 3120, SAN DIEGO, CA, 92101, US

(21) Appl. No.: 11/039,700

(22) Filed: Jan. 19, 2005

(51) Int. Cl. H04L 9/32

(52) U.S. Cl. 726/5

(57) ABSTRACT

Various methods are disclosed for ensuring compliance with operating system license requirements in a server blade center environment in which a server blade may have plural images of an O.S., one for each of plural thin clients serviced by the blade.

### FIELD OF THE INVENTION

The present invention relates generally to blade servers.

### BACKGROUND OF THE INVENTION

Slim, hotswappable blade servers fit in a single chassis like books in a bookshelf. Each is an independent server, with its own processors, memory, storage, network controllers, operating system and applications. A blade server simply slides into a bay in the chassis and plugs into a mid- or backplane, sharing power, fans, floppy drives, switches, and ports with other blade servers.

The benefits of the blade approach includes obviating the need for running hundreds of cables through racks just to add and remove servers. With switches and power units shared, precious space is freed up, and blade servers enable higher density with far greater ease.

Indeed, immediate, real-life benefits make blade-server technology an important contributor to an ongoing revolution toward on-demand computing. Along with other rapidly emerging technologies (grid computing, autonomic computing, Web services, distributed computing, etc.), blade servers' efficiency, flexibility, and cost-effectiveness are helping to make computing power reminiscent of a utility service like electrical power, i.e., as much as needed for use whenever it is needed.

For instance, in one application a blade server in a chassis of blade servers may be used as the processor for a thin client device that might have minimal computing capability, e.g., that might have a very small processor and a minimal operating system. In such an application, a customer may be able to time-share a single blade server among multiple thin client devices, thereby saving resources. The blade server would essentially have a full operating system image that is customized for each client device/user it services.

As critically recognized herein, however, licensing considerations may require that fees be paid for each operating system image used by the blade server. Furthermore, the licensing fees may be required per user (human user) and/or per client device.

### SUMMARY OF THE INVENTION

A method for license management is disclosed for a system that includes a client device and a client blade server having the capability to establish an operating system image dedicated to a client device, such that the client device can access the operating system image in the client server remotely to undertake computing operations. The method includes providing a base operating system (O.S.) in the client server. The base O.S. has a software module such as a driver for establishing connection to a license server. When the client device accesses the client server for the first time, the O.S. image pertaining to the client is generated from the base O.S., including the driver. It is then determined whether a user of the client device and/or the client device itself is associated with a valid license, and if so, the client device is permitted to execute operations using the O.S. image in the client server. Otherwise, the driver in the O.S. image connects to the license server to obtain a license before permitting the client device to execute operations using the O.S. image in the client server.

The client server may be a blade server in a blade center and the client device may be a thin client.

Some implementations of the method may include, at the client server, receiving from the client device a user identification and/or a client device identification, and then, at the client server or at the license server, determining whether the identification or identifications correlates to a valid license. Data that is useful for licensing accounting can be generated. In other implementations, a license key or license information that is useful for determining a license key is received from the client device, as part of the determining act. In still other implementations, licensing information is received from a trusted platform module (TPM) in the client device, with the licensing information representing a digitally signed package using the root signature of the TPM. Or, a user identification may be received from a biometric sensor or smart card in the client device as part of determining whether a valid user license exists.

In another aspect, a computer system includes a blade client server, a client device seeking to use an operating system (O.S.) contained in the blade client server for client device computing operations, and means for enforcing compliance with O.S. licensing requirements prior to permitting execution of the computing operations.

In still another aspect, a service for ensuring computer software license compliance includes receiving, from a client blade server in a blade center, information representing at least one of: a client device seeking to remotely use an operating system in the client blade server as its own operating system, and a user of the client device. The service also includes determining whether the information is correlated to a valid license.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a front, top and right side exploded perspective view of a server blade system of the present invention;

FIG. 2 is a rear, top and left side perspective view of the rear portion of the server blade system;

FIG. 3 is a flow chart of the overall logic;

FIG. 4 is a flow chart of logic that may be implemented on the server side for ensuring user and/or client device license compliance;

FIG. 5 is a flow chart of logic that may be implemented on the client device side and server side for ensuring client device license compliance;

FIG. 6 is a flow chart of logic that may be implemented on the client device side and server side for ensuring user license compliance; and

FIG. 7 is a flow chart of logic that may be implemented on the client device side and server side for ensuring client device license compliance.

### DETAILED DESCRIPTION OF THE PREFERRED EMBODIMENT

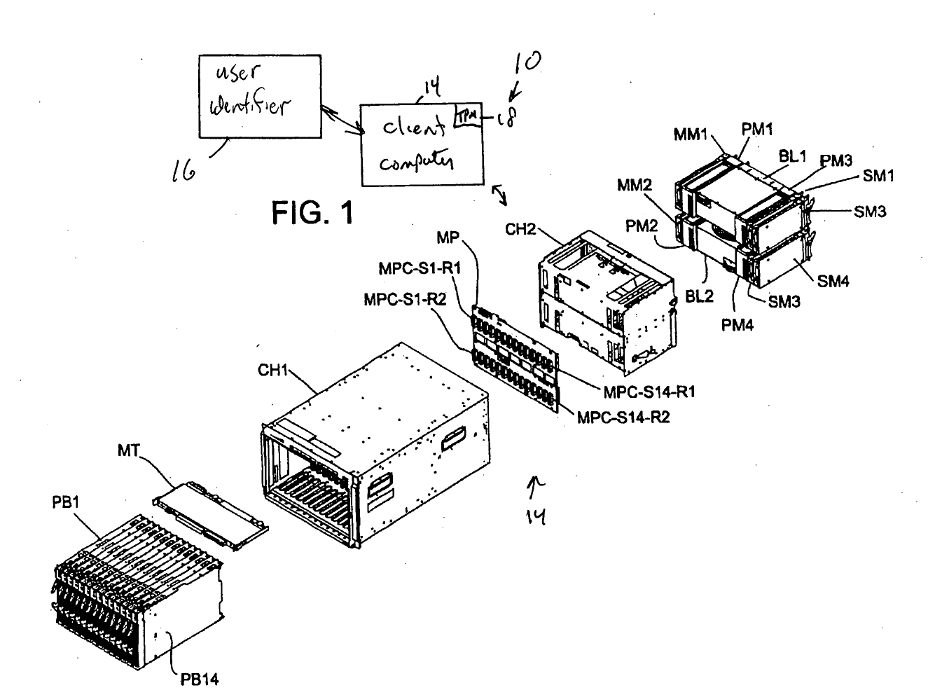

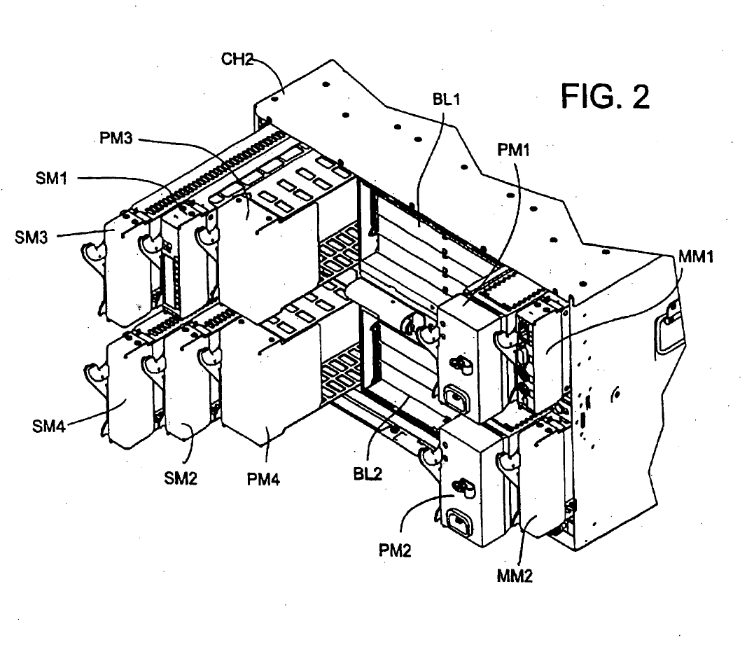

The present assignee's U.S. Pat. No. 6,771,499, incorporated herein by reference, sets forth one non-limiting blade server system with which the present invention can be used. For convenience, FIGS. 1 and 2 show such a system, generally designated 10, in which one or more client devices 12 communicate over wired or wireless paths with a blade server center, generally designated 14. Any appropriate computing device may function as the client device. Generally although not exclusively, the client device is a so-called “thin” client device. A user identification device 16 such as a “smart card” or biometric device may be operably engaged with the client device 12. Also, in some implementations a security chip 18 such as a trusted platform module (TPM) may be included in the client device 12.

Accordingly, focussing on a non-limiting implementation of the blade center 14, a main chassis CH1 houses all the components of the server blade center 14. Up to fourteen or more processor blades PB1 through PB14 (or other blades, such as storage blades) are hot-pluggable into the fourteen slots in the front of chassis CH1, any one or more of which could function as client servers and any one or more of which could function as license servers, although the present license server may be implemented by a component apart from the blade center; in either case the license server may be owned by a third party service provider. The term “server blade”, “processor blade”, or simply “blade” are used interchangeably herein, but it should be understood that these terms are not limited to blades that only perform “processor” or “server” functions, but also include blades that perform other functions, such as storage blades, which typically include hard disk drives and whose primary function is data storage.

Processor blades provide the processor, memory, hard disk storage and firmware of an industry standard server. In addition, they include keyboard, video and mouse (“KVM”) selection via a control panel, an onboard service processor, and access to the floppy and CD-ROM drives in the media tray. A daughter card is connected via an onboard PCI-X interface and is used to provide additional high-speed links to switch modules SM3 and SM4. Each processor blade also has a front panel with five LED's to indicate current status, plus four push-button switches for power on/off, selection of processor blade, reset, and NMI for core dumps for local control.

Blades may be “hot swapped” without affecting the operation of other blades in the system. A server blade is typically implemented as a single slot card (394.2 mm by 226.99 mm); however, in some cases a single processor blade may require two slots. A processor blade can use any microprocessor technology as long as it compliant with the mechanical and electrical interfaces, and the power and cooling requirements of the server blade system.

For redundancy, processor blades have two signal and power connectors; one connected to the upper connector of the corresponding slot of midplane MP, and the other connected to the corresponding lower connector of the midplane. Processor blades interface with other components in the server blade system via the following midplane interfaces: 1) Gigabit Ethernet (two per blade; required); 2) Fibre Channel (two per blade; optional); 3) management module serial link; 4) VGA analog video link; 4) keyboard/mouse USB link; 5) CD-ROM and floppy disk drive (“FDD”) USB link; 6) twelve VDC power; and 7) miscellaneous control signals. These interfaces provide the ability to communicate to other components in the server blade system such as management modules, switch modules, the CD-ROM and the FDD. These interfaces are duplicated on the midplane to provide redundancy. A processor blade typically supports booting from the media tray CDROM or FDD, the network (Fibre channel or Ethernet), or its local hard disk drive.

A media tray MT includes a floppy disk drive and a CD-ROM drive that can be coupled to any one of the blades. The media tray also houses an interface board on which is mounted interface LED'S, a thermistor for measuring inlet air temperature, and a four-port USB controller hub. System level interface controls consist of power, location, over temperature, information, and general fault LED's and a USB port.

Midplane circuit board MP is positioned approximately in the middle of chassis CH1 and includes two rows of connectors; the top row including connectors MPC-S1-R1 through MPC-S14-R1, and the bottom row including connectors MPC-S1-R2 through MPC-S14-R2. Thus, each one of the blade slots includes one pair of midplane connectors located one above the other (e.g., connectors MPC-S1-R1 and MPC-S1-R2) and each pair of midplane connectors mates to a pair of connectors at the rear edge of each processor blade (not visible in FIG. 1).

FIG. 2 is a rear, top and left side perspective view of the rear portion of the server blade system. Referring to FIGS. 1 and 2, a chassis CH2 houses various hot plugable components for cooling, power, control and switching. Chassis CH2 slides and latches into the rear of main chassis CH1.

Two hot plugable blowers BL1 and BL2 include backward-curved impeller blowers and provide redundant cooling to the server blade system components. Airflow is from the front to the rear of chassis CH1. Each of the processor blades PB1 through PB14 includes a front grille to admit air, and low-profile vapor chamber based heat sinks are used to cool the processors within the blades. Total airflow through the system chassis is about three hundred cubic feet per minute at seven-tenths inches H2O static pressure drop. In the event of blower failure or removal, the speed of the remaining blower automatically increases to maintain the required air flow until the replacement unit is installed. Blower speed control is also controlled via a thermistor that constantly monitors inlet air temperature. The temperature of the server blade system components are also monitored and blower speed will increase automatically in response to rising temperature levels as reported by the various temperature sensors.

Four hot plugable power modules PM1 through PM4 provide DC operating voltages for the processor blades and other components. One pair of power modules provides power to all the management modules and switch modules, plus any blades that are plugged into slots one through six. The other pair of power modules provides power to any blades in slots seven through fourteen. Within each pair of power modules, one power module acts as a backup for the other in the event the first power module fails or is removed. Thus, a minimum of two active power modules are required to power a fully featured and configured chassis loaded with fourteen processor blades, four switch modules, two blowers, and two management modules. However, four power modules are needed to provide full redundancy and backup capability. The power modules are designed for operation between an AC input voltage range of 200VAC to 240VAC at 50/60 Hz and use an IEC320 C14 male appliance coupler. The power modules provide +12VDC output to the midplane from which all server blade system components get their power. Two +12VDC midplane power buses are used for redundancy and active current sharing of the output load between redundant power modules is performed.

Management modules MM1 through MM4 are hot-pluggable components that provide basic management functions such as controlling, monitoring, alerting, restarting and diagnostics. Management modules also provide other functions required to manage shared resources, such as the ability to switch the common keyboard, video, and mouse signals among processor blades.

Having reviewed one non-limiting blade server system 14, attention is now directed to FIG. 3, which shows the logic that can be executed by a processor or processors in the blade server center 14 and/or in consonance with logic in the client device 12. The processor may be a management processor, and/or a blade processor, and/or other processor, and the logic may stored on a data storage device such as but not limited to a hard disk drive or solid state memory device.

Commencing at block 20 of FIG. 3, a base operating system is provided to the client blade server. The O.S. is an O.S. that a thin client may desire to execute remotely on the client blade server as though it were its own O.S., i.e., as though the O.S. were actually resident on thin client itself. The O.S. may be, e.g., Windows XP, which terms may be subject to trademark protection. The O.S. preferably is modified to incorporate a driver such as a software service that connects to the license server as set forth further below.

Moving to block 22, when a new user and/or client device attempts for the first time to connect to the client blade server to execute the O.S., the process moves to block 24 to make a copy (“image”) of the O.S. that is or can be tailored to the particular client or user. Making an image of the base O.S. may be done in accordance with O.S. imaging principles known in the art. Then, at block 26 licensing logic is executed to ensure licensing compliance.

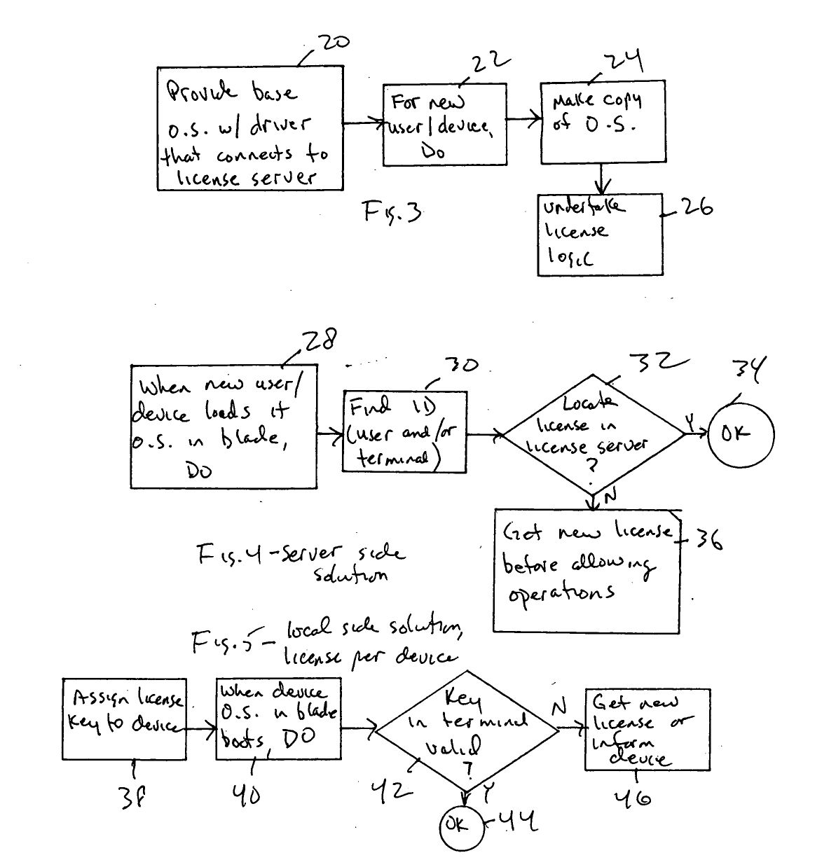

FIG. 4 shows one non-limiting example of such logic. Commencing at block 28, when a new user and/or new client device attempts to cause its client blade server to load the O.S. image associated with the client device, the logic moves to block 30 to receive from the client device a user identification (such as, e.g., a user name or password) and/or a client device identification (such as, e.g., a processor serial number, etc.). Decision diamond 32 indicates that the client blade server uses the driver mentioned above to access the license server with the information, which determines whether a valid license is correlated to the identity information. If so, normal operation of the O.S. in the client blade server under control of user input at the client device is permitted at state 34. Otherwise, a new license key is requested at block 36 (and/or the client device is informed of the lack of license) and correlated to the identity information before the client device is allowed to execute the O.S. on the client blade server. In some implementations the owner of the blade center purchases a pool of license keys, and in these implementations the license server sends a new license key to the client blade server for each new client/user sought to be added, generating accounting information (such as decrementing the number of remaining license keys) that is useful for license management and compliance monitoring. When all license keys have been used, the license server can notify the client blade server or other entity that more license keys must be purchased. The licenses of clients that have been inactive for prolonged periods (the length of which may be defined by the relevant licensor) may be recycled if desired, i.e., a license key may be placed back into the pool of available keys in the event that the associated client device has been inactive by reason of, e.g., malfunctioning, be disposed of, etc.

FIG. 5 shows an alternate licensing logic that commences at block 38, wherein a license key is assigned to a client device and stored in, e.g., its basic input/output system (BIOS) or hard disk drive (HDD), or calculated by a unique combination of hardware identifications such as but not limited to HDD serial number, MAC address, processor serial number, MTM serial number, etc. At block 40, when the device causes its O.S. image in the client blade server to boot, the logic moves to decision diamond 42, wherein the license key is retrieved from the client device and either the client blade server or license server, via the client blade server, determines whether it is valid. If so, normal operation of the O.S. in the client blade server under control of user input at the client device is permitted at state 44. Otherwise, a new license key is requested at block 46.

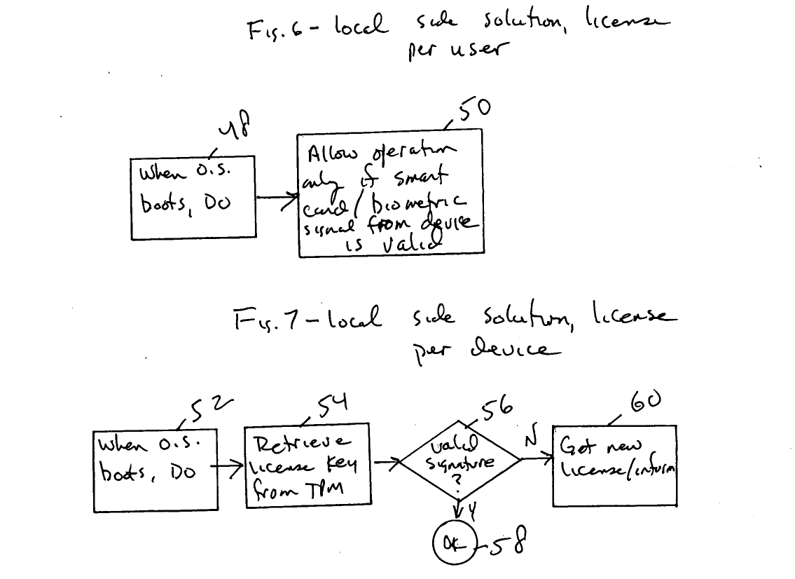

FIG. 6 shows yet another alternate licensing logic that commences at block 48, wherein the client device causes its O.S. image in the client blade server to boot. The logic then moves to block 50 to allow operation of the O.S. in the client blade server under control of user input at the client device only if human user identification (which can be received from, e.g., a smart card inserted into the client device, or in a signal generated by a biometric sensor on the client device) is correlated to the existence of a valid license. The correlation may be performed by the client blade server and/or by the license server.

FIG. 7 shows still a further licensing logic that commences at block 52, wherein the client device causes its O.S. image in the client blade server to boot. The logic then moves to block 54 to access license information, which may be a license key signed by the TPM 18 shown in FIG. 1. At decision diamond 56, it is determined whether the signature/licensing information is valid, and if so, normal operation of the O.S. in the client blade server under control of user input at the client device is permitted at state 58. Otherwise, a new license key is requested at block 60.

While the particular SYSTEM AND METHOD FOR LICENSE MANAGEMENT IN BLADE SERVER SYSTEM as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A method for license management in a system including at least one client server having the capability to establish an operating system (O.S.) image dedicated to a client device, the client device being configured to access the operating system image in the client server remotely to undertake computing operations, the method comprising:
providing a base O.S. in the client server, the base O.S. having a software module for establishing connection to a license server;
when the client device accesses the client server for the first time, generating the O.S. image, the O.S. image including the software module;
determining whether at least one of: a user of the client device, and the client device, is associated with a valid license, and if so, permitting the client device to execute operations using the O.S. image in the client server; otherwise:
using the software module to access the license server to obtain a license for at least one of: a user of the client device, and the client device, before permitting the client device to execute operations using the O.S. image in the client server.

2. The method of claim 1, wherein the client server is a blade server.

3. The method of claim 2, wherein the client device is a thin client.

4. The method of claim 1, comprising:
at the client server, receiving from the client device at least one of: a user identification, and a client device identification;
at the client server or at the license server, determining whether the identification or identifications correlates to a valid license, to execute the act of determining whether at least one of: a user of the client device, and the client device, is associated with a valid license.

5. The method of claim 4, wherein both the user identification and client device identification are used to determine whether a valid license is correlated to.

6. The method of claim 1, comprising generating data useful for licensing accounting as part of the using act.

7. The method of claim 1, wherein the act of determining includes:
receiving, from the client device, a license key or license information useful for determining a license key, as part of the determining act.

8. The method of claim 7, wherein licensing information is received from a trusted platform module (TPM) in the client device, the licensing information representing a TPM signature.

9. The method of claim 1, wherein a user identification from a biometric sensor or smart card is received from the client device as part of the determining act.

10. A computer system, comprising:
at least one blade client server;
at least one client device seeking to use an operating system (O.S.) contained in the blade client server for client device computing operations; and
means for enforcing compliance with O.S. licensing requirements prior to permitting execution of the computing operations.

11. The system of claim 10, wherein the means for enforcing includes:
means for determining whether at least one of: a user of the client device, and the client device, is associated with a valid license; and
means responsive for the means for determining for selectively permitting the client device to execute operations using the O.S. image in the client blade server, and for obtaining a license for at least one of: a user of the client device, and the client device.

12. The system of claim 11, comprising, at the client blade server, means for receiving, from the client device, a license key or license information useful for determining a license key.

13. The system of claim 12, wherein licensing information is received from a trusted platform module (TPM) in the client device, the licensing information representing a TPM signature.

14. The system of claim 11, wherein a user identification from a biometric sensor or smart card is received from the client device.

15. A service for ensuring computer software license compliance, comprising:
receiving, from a client blade server in a blade center, information representing at least one of: a client device seeking to remotely use an operating system in the client blade server as its own operating system, and a user of the client device; and
determining whether the information is correlated to a valid license.

16. The service of claim 15, wherein the information represents a client device.

17. The service of claim 15, wherein the information represents a user of the client device.

18. The service of claim 17, wherein the information represents a client device.

19. The service of claim 15, comprising generating licensing accounting information based on the information.

20. The service of claim 19, comprising providing the licensing accounting information to a vendor of the operating system.
